(19) United States
(12) Patent Application Publication
(10) Pub. No.: US 2026/0089379 A1
(43) Pub. Date: Mar. 26, 2026

(54) CABLE-TYPE DETECTION DEVICE AND DETECTION METHOD FOR DEFECTS AND CONDITIONS OF DRAINAGE PIPELINES

(71) Applicant: North China Municipal Engineering Design & Research Institute Co., LTD., Tianjin (CN)

(72) Inventors: Haozheng WANG, Tianjin (CN); Fansong WU, Tianjin (CN); Zhiyuan XIE, Tianjin (CN); Qiuyi WANG, Tianjin (CN); Lu LU, Tianjin (CN); Zhixiao LIU, Tianjin (CN)

(73) Assignee: North China Municipal Engineering Design & Research Institute Co., LTD., Tianjin (CN)

(21) Appl. No.: 19/398,642

(22) Filed: Nov. 24, 2025

Related U.S. Application Data
(63) Continuation of application No. PCT/CN2025/118574, filed on Sep. 3, 2025.

(30) Foreign Application Priority Data
Jun. 17, 2025 (CN) 202510805758.0

(51) Int. Cl. H04N 23/50; B65H 75/40; B65H 75/44; H04N 23/68; H04N 23/90

(52) U.S. Cl. CPC H04N 23/555; B65H 75/40; B65H 75/4486; H04N 23/685; H04N 23/90

(57) ABSTRACT

A cable-type detection device for defects and conditions of drainage pipelines includes a detection system and a cable system. The detection system includes an inspection carrier and camera devices. The camera devices are mounted on the inspection carrier. The cable system includes an integrated cable, a connecting cable, a cable restraint and protection device, and a control device. The control device includes a drive unit, a transmission unit, a first cable reel, a second cable reel, and an integrated controller. A first end of the integrated cable is connected to an integrated cable socket of the inspection carrier. A second end of the integrated cable is wound on the first cable reel and electrically connected to the integrated controller. A first end of the connecting cable is connected to a second end of the inspection carrier. A second end of the connecting cable is wound on the second cable reel.

### CROSS-REFERENCE TO RELATED APPLICATIONS

This application is a continuation of International Patent Application No. PCT/CN2025/118574 with a filing date of Sep. 3, 2025, designating the United States, now pending, and further claims priority to Chinese Patent Application No. 202510805758.0 with a filing date of Jun. 17, 2025. The content of the aforementioned applications, including any intervening amendments thereto, is incorporated herein by reference.

### TECHNICAL FIELD

This application relates to the field of drainage pipeline detection technology, and in particular, to a cable-type detection device and detection method for defects and conditions of drainage pipelines.

### BACKGROUND

The urban pipeline network system not only plays a significant role in collecting and transporting rainwater, urban domestic sewage, and industrial wastewater but also undertakes the important responsibilities of urban water environment pollution prevention, drainage, and flood control. However, due to natural aging, sewage erosion, stress damage, and other factors, various defects may occur in drainage pipelines, such as collapse, blockage, deformation, and misalignment. These defects can not only affect the normal functions of the drainage pipelines but also cause serious issues such as environmental pollution, road waterlogging, and traffic inconvenience. Therefore, the detection of the defects in the drainage pipelines is particularly important.

A closed circuit television (CCTV) detection technology, a sonar detection technology, and other detection technologies are typically used for the detection of the defects in the drainage pipelines. The CCTV detection technology enables real-time acquisition and transmission of video information inside the drainage pipelines, allowing for real-time acquisition of internal defect images of the pipelines. However, it is necessary to carry out appropriate plugging, pumping, and cleaning of the pipelines before implementation, resulting in relatively low detection efficiency. The sonar detection technology enables the detection of the defects in the drainage pipelines under full-pipe conditions without performing plugging or water diversion of the pipelines. However, the sonar detection technology is not applicable to the detection of the defects in pipelines under non-full-pipe conditions and makes it difficult to detect the defects above the liquid level. Therefore, the current drainage pipeline defect detection technology is difficult to efficiently solve the problems in the existing detection technologies, and a more efficient, applicable, and effective detection technology needs to be developed.

### SUMMARY OF PRESENT INVENTION

This application provides a cable-type detection device and detection method for defects and conditions of drainage pipelines, so as to solve at least one of the technical problems in the related art to some extent. The technical solutions of this application are as follows:

According to a first aspect of an embodiment of this application, a cable-type detection device for defects and conditions of drainage pipelines is provided, including: a detection system and a cable system, where the detection system includes an inspection carrier and camera devices; the camera devices are mounted on the inspection carrier; the cable system includes an integrated cable, a connecting cable, a cable restraint and protection device, and a control device; the control device includes a drive unit, a transmission unit, a first cable reel, a second cable reel, and an integrated controller; a first end of the integrated cable is connected to an integrated cable socket at a first end of the inspection carrier; a second end of the integrated cable is wound on the first cable reel and electrically connected to the integrated controller; the integrated cable socket is connected to the camera devices; a first end of the connecting cable is connected to a second end of the inspection carrier; a second end of the connecting cable is wound on the second cable reel; the drive unit is configured to drive the first cable reel and the second cable reel to rotate simultaneously via the transmission unit, so that one of the integrated cable and the connecting cable is released while the other is retracted; and the cable restraint and protection device includes a well protection device and a pipeline trajectory restraint structure that are configured to provide protection for and trajectory restraint to the integrated cable and the connecting cable;

the inspection carrier includes a carrier connector, two inverted-U-shaped carrier frames, and a shock-absorbing and stabilizing swing curtain, where a first end of the carrier connector is internally provided with the integrated cable socket; a second end of the carrier connector is connected to the connecting cable; the two carrier frames semi-enclose the two ends of the carrier connector respectively; a side of the shock-absorbing and stabilizing swing curtain is inverted-T-shaped; a top of the shock-absorbing and stabilizing swing curtain is slidably mounted on a middle part of the carrier connector; the two camera devices are respectively disposed at two ends of an inverted-T-shaped lower part of the shock-absorbing and stabilizing swing curtain; and the integrated cable socket is connected to the two camera devices via a video cable; and

the shock-absorbing and stabilizing swing curtain includes a swing curtain body, a first rolling shaft, a first shaft sleeve, and plugs, where an inner center of the swing curtain body is fixedly connected to the hollow first shaft sleeve; the first rolling shaft passes through the first shaft sleeve and has two ends respectively connected to the plugs; left and right sides of an upper surface of the carrier connector are provided with symmetrically distributed movement tracks; the movement tracks are located between the carrier connector and the carrier frames; and the plugs at two ends of the first rolling shaft fit with the movement tracks.

According to a second aspect of an embodiment of this application, a drainage pipeline detection method is provided, where the drainage pipeline detection method is implemented using the cable-type detection device for defects and conditions of drainage pipelines. The method includes:

turning on the camera devices, and driving, by the drive unit, the first cable reel and the second cable reel to rotate simultaneously, so that the integrated cable is retracted onto the first cable reel while the connecting cable is released from the second cable reel, thereby enabling the detection system to move along a drainage pipeline; and

obtaining video information acquired by the camera devices from the integrated controller, and performing detection on the drainage pipeline based on the video information.

In some implementations, a top of the detection system is provided with an ultrasonic sensor, and a side of the detection system is provided with an ultrasonic liquid level sensor. The method further includes:

acquiring, by the ultrasonic sensor, a first distance between the detection system and a top of the drainage pipeline;

acquiring, by the ultrasonic liquid level sensor, a second distance between the detection system and a liquid level inside the drainage pipeline;

summing the first distance, the second distance, and a third distance between the ultrasonic sensor and the ultrasonic liquid level sensor to obtain a first height from the top of the drainage pipeline to the liquid level; and

calculating a difference between a cross-sectional diameter of the drainage pipeline and the first height to obtain liquid level information of the drainage pipeline.

The technical solutions of the embodiments of this application provide at least the following beneficial effects:

The detection device of this application is applicable to the detection of the defects in the drainage pipelines, can detect the defects above the liquid levels of the drainage pipelines, and enables real-time acquisition and transmission of video information inside the drainage pipelines in a case that a pipeline network operates normally, thereby detecting the defects in the drainage pipelines. The detection device in this solution has a small volume, is applicable to the detection of drainage pipelines of various specifications, and offers high detection efficiency.

Additional aspects and advantages of this application will be given in part in the following description, part of which will become apparent from the following description or be learned from the practice of this application.

### BRIEF DESCRIPTION OF THE DRAWINGS

The above and/or additional aspects and advantages of this application will become obvious and easy to understand from the description of the embodiments with reference to the following drawings.

FIG. 1 is a schematic diagram of an overall structure of a cable-type detection device for defects and conditions of drainage pipelines according to an embodiment of this application;

FIG. 2 is a schematic diagram of a partial structure of a detection system according to an embodiment of this application;

FIG. 3 is a partially enlarged view of an upper part of a shock-absorbing and stabilizing swing curtain according to an embodiment of this application;

FIG. 4 is a partially enlarged view of a structure of a rotation stabilizer according to an embodiment of this application;

FIG. 5 is a schematic structural diagram of a position of an inspection well of a cable restraint and protection device according to an embodiment of this application;

FIG. 6 is a schematic structural diagram of a position of a horizontal drainage pipeline of a cable restraint and protection device according to an embodiment of this application;

FIG. 7 is a schematic diagram of a partial structure of a cabinet according to an embodiment of this application;

FIG. 8 is a partially enlarged view of a gear fixing structure according to an embodiment of this application;

FIG. 9 is a partially enlarged view of a bottom of a second cable reel according to an embodiment of this application; and

FIG. 10 is a partially enlarged view of a rectangular cable restraint structure according to an embodiment of this application.

In the drawings:

1. inspection carrier; 2. plug; 3. movement track; 4. first shaft sleeve; 5. shock-absorbing and stabilizing swing curtain; 6. first rolling shaft; 7. first side rail; 8. first ball; 9. ultrasonic sensor; 10. integrated cable socket; 11. video cable; 12. integrated cable; 13. cable buffer; 14. first safety fastener; 15. first fixing cone; 16. first annular groove; 17. carrier connector; 18. first nut; 19. first clamping slot; 20. first fixing ring; 21. connecting cable; 22. first screw cap; 23. first fixing shaft; 24. second ball; 25. rotation stabilizer; 26. low-elasticity spring; 27. main spring; 28. first protection cap; 29. first fill light; 30. main camera; 31. waterproof eave; 32. protection roller; 33. top camera; 34. second fill light; 35. fixing rod; 36. cable through hole; 37. first ball groove; 38. third ball; 39. second fixing cone; 40. hoisting rod; 41. first buffer spring; 42. second safety fastener; 43. fourth ball; 44. second ball groove; 45. cable threading sleeve; 46. first cable protection sleeve; 47. fixing spring; 48. second cable protection sleeve; 49. spring clamp; 50. cabinet; 51. storage battery; 52. communication antenna; 53. integrated controller; 54. hole; 55. power wire; 56. power controller; 57. first motor; 58. drive gear; 59. second driven gear; 60. second rotating rod; 61. first chain; 62. gear fixing rod; 63. second clamping slot; 64. first base plate; 65. fifth ball; 66. second cable reel; 67. second middle shaft; 68. support plate; 69. cabinet door; 70. cable protection cap; 71. first base plate support rod; 72. third clamping slot; 73. second base plate; 74. sixth ball; 75. first middle shaft; 76. control cable; 77. first gear; 78. chain rotating shaft; 79. third driven gear; 80. horizontal rod; 81. vertical rod; 82. limit pulley; 83. second chain; 84. motor control box; 85. drainage pipeline; 86. ultrasonic liquid level sensor; 87. first cable reel; 88. inspection well; 89. first driven gear; and 90. carrier frame.

### DETAILED DESCRIPTION OF THE EMBODIMENTS

To enable those of ordinary skill in the art to better understand the technical solutions of this application, the following will clearly and completely describe the technical solutions in the embodiments of this application with reference to the accompanying drawings.

The embodiments of this application are described in detail below. Examples of the embodiments are shown in the accompanying drawings, and throughout the accompanying drawings, the same or similar reference signs indicate the same or similar components or components with the same or similar functions. The embodiments described below with reference to the accompanying drawings are illustrative and are intended to explain this application. They should not be construed as limitations on this application.

It should be noted that in the specification, claims, and accompanying drawings of this application, the terms “first”, “second”, and the like are intended to distinguish between similar objects rather than to describe a specific order or sequence. It should be understood that data used in this way may be interchangeable in appropriate circumstances such that the embodiments of this application can be implemented in other orders than the order illustrated or described herein. The implementations described in the following exemplary embodiments do not represent all implementations consistent with this application. Instead, they are merely examples of devices and methods consistent with some aspects of this application as detailed in the appended claims. In the description of this application, the meaning of “a plurality of” is at least two, for example, two or three, unless otherwise defined explicitly and specifically.

The following describes a cable-type detection device and detection method for defects and conditions of drainage pipelines according to embodiments of this application with reference to the accompanying drawings.

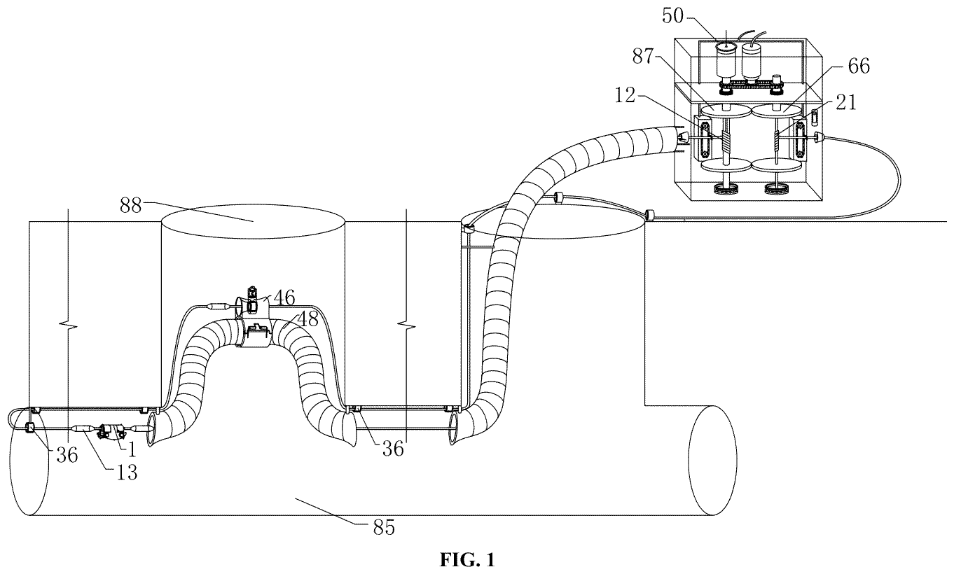

An embodiment of this application provides a cable-type detection device for defects and conditions of drainage pipelines. As shown in FIG. 1 to FIG. 10, the cable-type detection device for defects and conditions of drainage pipelines includes a detection system and a cable system. The detection system includes an inspection carrier 1 and camera devices. The camera devices are mounted on the inspection carrier 1. The cable system includes an integrated cable 12, a connecting cable 21, a cable restraint and protection device, and a control device. The control device includes a drive unit, a transmission unit, a first cable reel 87, a second cable reel 66, and an integrated controller 53. A first end of the integrated cable 12 is connected to an integrated cable socket 10 at a first end of the inspection carrier 1. A second end of the integrated cable 12 is wound on the first cable reel 87 and electrically connected to the integrated controller 53. The integrated cable socket 10 is connected to the camera devices. A first end of the connecting cable 21 is connected to a second end of the inspection carrier 1. A second end of the connecting cable 21 is wound on the second cable reel 66. The drive unit is configured to drive the first cable reel 87 and the second cable reel 66 to rotate simultaneously via the transmission unit, so that one of the integrated cable 12 and the connecting cable 21 is released while the other is retracted. The cable restraint and protection device includes a well protection device and a pipeline trajectory restraint structure that are configured to provide protection for and trajectory restraint to the integrated cable 12 and the connecting cable 21.

Thus, signals required by the inspection carrier 1 are transmitted through the integrated cable 12. A closed-loop track is formed by the integrated cable 12 in combination with the connecting cable 21. The drive unit is configured to drive the first cable reel 87 and the second cable reel 66 to rotate simultaneously, so that the integrated cable 12 is retracted onto the first cable reel 87 while the connecting cable is released from the second cable reel 66, thereby enabling the detection system to move along a drainage pipeline 85. During movement, video information inside the drainage pipeline 85 is acquired by the camera devices to perform detection on the drainage pipeline 85 based on the video information. The integrated cable 12 can be inserted into the integrated cable socket 10 to enable transmission of signals and power.

The cable-type detection device for the defects and the conditions of the drainage pipelines according to this embodiment of this application is applicable to the detection of the defects in the drainage pipelines, can detect the defects above the liquid levels of the drainage pipelines, and enables real-time acquisition and transmission of video information inside the drainage pipelines in a case that a pipeline network operates normally, thereby detecting the defects in the drainage pipelines. The detection device in this solution has a small volume, is applicable to the detection of drainage pipelines of various specifications, and offers high detection efficiency. The detection device is applied to a municipal drainage pipeline network and configured to detect defects and conditions of the drainage pipeline network and acquire image data inside pipelines.

In this solution, the integrated cable and the connecting cable at two ends of the inspection system are used to form a cable-type movement track within the drainage pipeline. This directly reduces wheels and corresponding connecting components typically required by conventional inspection robots. As a result, a structural part, located within the drainage pipeline, of the detection device in this solution has smaller volume and lighter weight, making it applicable to drainage pipelines of various specifications. The control device can flexibly retract and release the integrated cable and the connecting cable, so that a movement speed of the detection system is not limited by operational conditions of the drainage pipeline. The movement speed of the detection system can be adjusted according to actual needs. This significantly enhances the maneuverability of the detection device, significantly reduces water diversion costs of the pipeline, and effectively improves the detection efficiency.

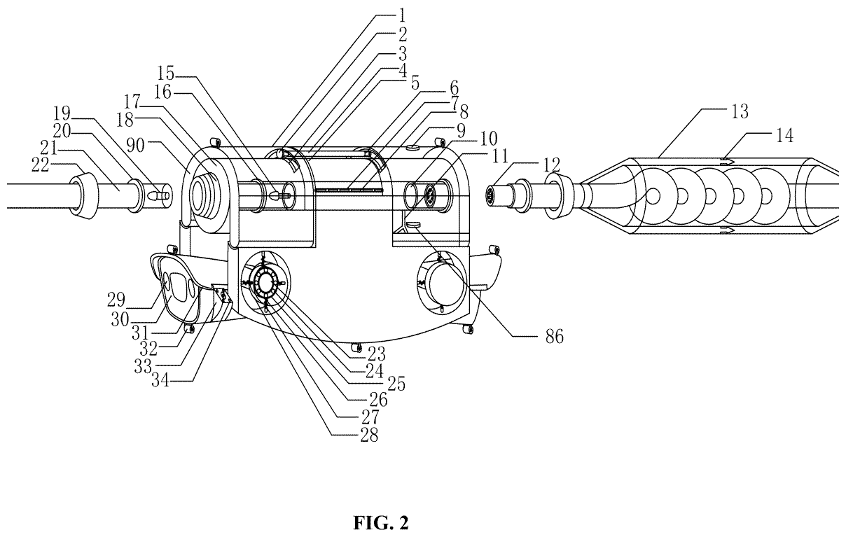

In some embodiments, as shown in FIG. 2, a top of the inspection carrier 1 is provided with an ultrasonic sensor 9. A side of the inspection carrier 1 is provided with an ultrasonic liquid level sensor 86. Both the ultrasonic sensor 9 and the ultrasonic liquid level sensor 86 are connected to the integrated cable socket 10. The ultrasonic sensor 9 can be configured to acquire a first distance between the ultrasonic sensor 9 and a top of the drainage pipeline 85. The ultrasonic liquid level sensor 86 can be configured to acquire a second distance between the ultrasonic liquid level sensor 86 and a liquid level inside the drainage pipeline. Liquid level information inside the drainage pipeline can be obtained by combining a known third distance between the ultrasonic sensor 9 and the ultrasonic liquid level sensor 86 and a cross-sectional diameter of the drainage pipeline.

According to the detection device of this embodiment, information data of the sensors is transmitted through a cable of the cable-type movement track, so that the signals are more stable, and the physical isolation interference from the drainage pipeline can be avoided.

In some embodiments, as shown in FIG. 2, the inspection carrier 1 includes a carrier connector 17, two inverted-U-shaped carrier frames 90, and a shock-absorbing and stabilizing swing curtain 5. A first end of the carrier connector 17 is internally provided with the integrated cable socket 10. A second end of the carrier connector 17 is connected to the connecting cable 21. The two carrier frames 90 semi-enclose the two ends of the carrier connector 17 respectively. The carrier frames 90 are fixedly connected to the carrier connector 17. A side of the shock-absorbing and stabilizing swing curtain 5 is inverted-T-shaped. A top of the shock-absorbing and stabilizing swing curtain 5 is slidably mounted on a middle part of the carrier connector 17. The two camera devices are respectively disposed at two ends of an inverted-T-shaped lower part of the shock-absorbing and stabilizing swing curtain. The integrated cable socket 10 is connected to the two camera devices via a video cable 11.

Thus, the carrier connector 17 is connected to the integrated cable 12 and the connecting cable 21 respectively.

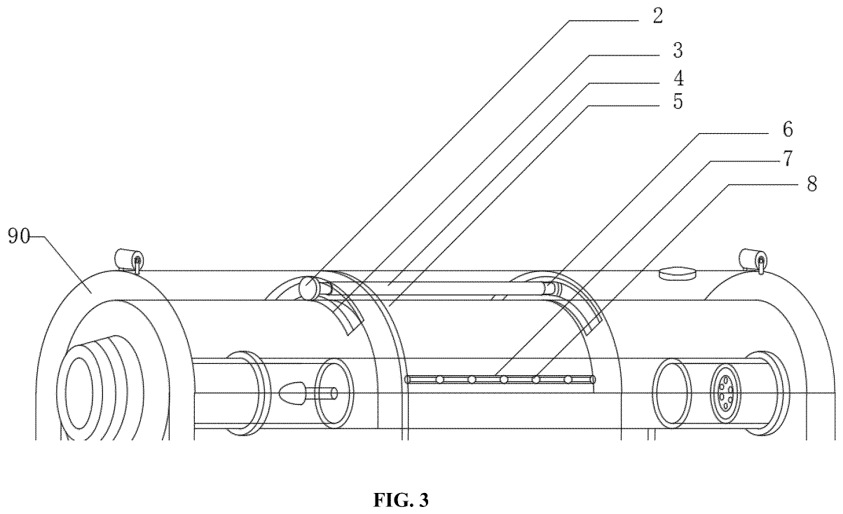

In some embodiments, as shown in FIG. 3, the shock-absorbing and stabilizing swing curtain 5 includes a swing curtain body, a first rolling shaft 6, a first shaft sleeve 4, and plugs 2. An inner center of the swing curtain body is fixedly connected to the hollow first shaft sleeve 4. The first rolling shaft 6 passes through the first shaft sleeve 4 and has two ends respectively connected to the plugs 2. Left and right sides of an upper surface of the carrier connector 17 are provided with symmetrically distributed movement tracks 3. The movement tracks 3 are located between the carrier connector 17 and the carrier frames 90. The carrier frames 90 can provide certain restraint to the plugs 2 at two ends of the first rolling shaft 6. The plugs 2 at the two ends of the first rolling shaft 6 fit with the movement tracks 3, so that the shock-absorbing and stabilizing swing curtain 5 swings on an upper surface of the carrier connector 17 with the first rolling shaft 6 as an axis.

Thus, the plugs 2 are embedded into the arc-shaped movement tracks 3, so that the first rolling shaft 6 can move along the movement tracks 3, allowing the shock-absorbing and stabilizing swing curtain 5 to swing with the first rolling shaft 6 as the axis, thereby allowing the camera devices to keep in a vertical state within a certain range by using the inertia of the shock-absorbing and stabilizing swing curtain 5, thereby ensuring camera angles of the camera devices.

In some embodiments, as shown in FIG. 3, the shock-absorbing and stabilizing swing curtain 5 further includes first side rails 7. The first side rails 7 are cylindrical and have a plurality of first balls 8 embedded therein. The first balls 8 are movably disposed inside the first side rails 7 and have small portions exposed outside the first side rails 7 via through holes on the first side rails 7. The two first side rails 7 are respectively fixed on inner surfaces of front and rear sides of the swing curtain body. The first balls 8 come into contact with an outer surface of the carrier connector 17.

Thus, the first side rails 7 can reduce frictional resistance at a contact position between the shock-absorbing and stabilizing swing curtain 5 and the carrier connector 17.

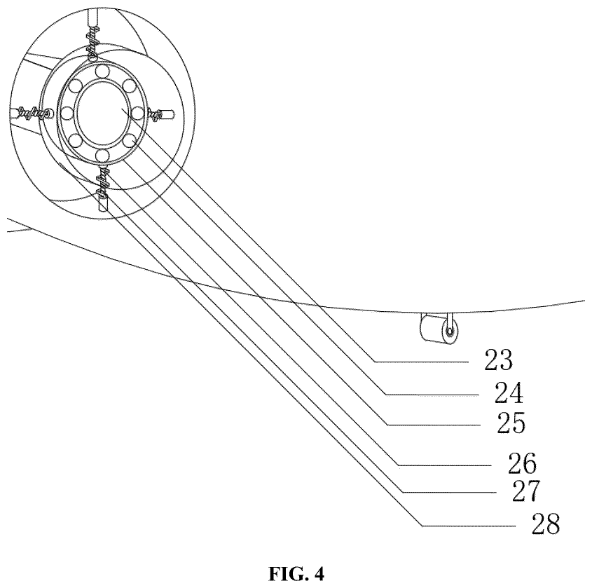

In some embodiments, as shown in FIG. 2 and FIG. 4, the inspection carrier 1 further includes rotation stabilizers 25. Two rotation stabilizers 25 are correspondingly disposed at the two ends of the inverted-T-shaped lower part of the shock-absorbing and stabilizing swing curtain 5 respectively and configured to stabilize the two camera devices. Each rotation stabilizer 25 includes a stabilizer body wrapped with second balls 24, a first fixing shaft 23, and a main spring 27. A center of the first fixing shaft 23 is connected to a position of a center of gravity of one camera device. Two ends of the first fixing shaft 23 are separately connected to a stabilizer body, and the stabilizer body is connected to a hole at a corresponding position on the shock-absorbing and stabilizing swing curtain 5 via the main spring 27. Two ends of the main spring 27 are further connected to low-elasticity springs 26. The main spring 27 penetrates into the low-elasticity springs 26 and is wound together with the low-elasticity springs 26 to form a dual stability guarantee.

Further, a first protection cap 28 is disposed at the exterior of each rotation stabilizer 25 and configured to protect the low-elasticity springs 26 and the main spring 27 and prevent the second balls 24 from slipping off. Thus, the first fixing shaft 23 is connected to the position of the center of gravity of one camera device, allowing the camera device to rotate around the rotation stabilizer 25 as a center.

In summary, the shock-absorbing and stabilizing swing curtain and the rotation stabilizers can significantly reduce the vibration interference caused by the cable-type movement track on the detection system during movement, making the camera devices of the detection system more stable and the acquired data more authentic and reliable.

In some embodiments, each camera device includes a main camera 30 and top cameras 33. An upper surface of the main camera 30 is provided with a waterproof eave 31. Two sides of the waterproof eave 31 extend in a streamlined shape and have bent-up bottoms. The two top cameras 33 are respectively disposed below the two sides of the waterproof eave 31. An upper surface of each top camera 33 is slanted. Front ends of the main camera 30 and the top cameras 33 are respectively provided with a first fill light 29 and second fill lights 34. The main camera 30 and the top cameras 33 are all multi-angle micro cameras.

Thus, the main camera 30 and the top cameras 33 can be configured to respectively acquire video information of the drainage pipeline 85 within different angle ranges, facilitating comprehensive pipeline detection. The top cameras 33 are slanted to smoothly guide water. In addition, with the multi-angle micro cameras used, full-range and dead-angle-free video and image acquisition can be achieved without a rotation structure, and the volumes and weights of the camera devices are significantly reduced.

In some embodiments, tops of two ends and a middle bottom of the inspection carrier 1 as well as a top and a bottom of the main camera 30 are each provided with a protection roller 32, reducing collision and frictional resistance during movement.

In some embodiments, the integrated cable 12 and the connecting cable 21 are each provided with a cable buffer 13. The cable buffer 13 is cylindrical and is configured to accommodate a wound cable. The cable buffer 13 includes two structural parts connected through a first safety fastener 14. The connecting cable 21 is provided with one or more cable buffers 13. The cable buffer 13 fits with cable through holes 36. The cable buffer 13 can pass through the cable through holes 36 without affecting the operation of the connecting cable 21.

Thus, the cylindrical cable buffer 13 can be configured to store the wound cable. A middle position of the cable buffer 13 is connected through the first safety fastener 14. When a pulling force reaches a set value, the cable buffer 13 can be separated to release the wound cable inside the cable buffer 13, thereby providing buffer protection to the cable when the cable is overstretched.

In some embodiments, the second end of the carrier connector 17 is internally provided with a first fixing cone 15 and a first annular groove 16. An end portion of the second end of the carrier connector 17 is provided with a first nut 18. The second end of the carrier connector 17 is in fitting connection with the first fixing cone 15 via a first clamping slot 19 provided at a center of the end portion. The second end of the carrier connector 17 is in fitting connection with the first annular groove 16 and the first nut 18 respectively via a first fixing ring 20 and a first screw cap 22 disposed on a periphery.

Thus, the first fixing cone 15 is embedded into the first clamping slot 19, and the first fixing ring 20 is embedded into the first annular groove 16, achieving fixation and waterproofing. The first nut 18 is screwed into the first screw cap 22, so that the first fixing ring 20 and the first screw cap 22 can form a dual waterproof protection.

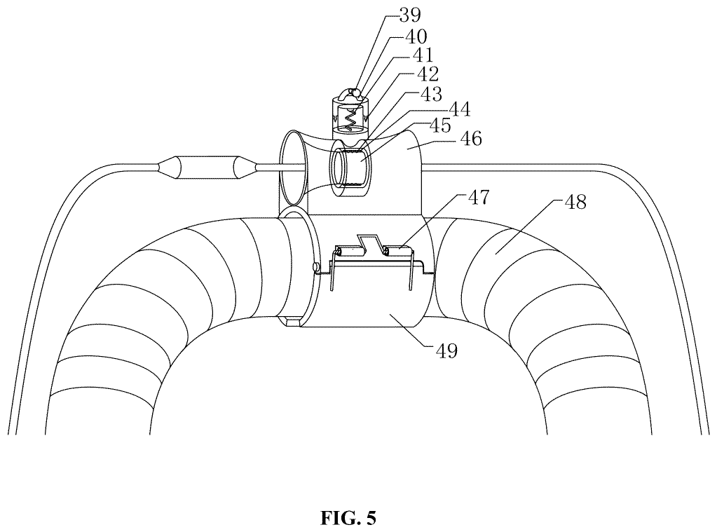

In some embodiments, as shown in FIG. 1 and FIG. 5, the well protection device includes a second cable protection sleeve 48, a spring clamp 49, a first cable protection sleeve 46, and a cable hoisting structure. A bottom of the cable hoisting structure is fixedly connected to the first cable protection sleeve 46. A bottom of the first cable protection sleeve 46 is fixedly connected to an upper part of the spring clamp 49. The spring clamp 49 is configured to clamp the second cable protection sleeve 48. The second cable protection sleeve 48 is configured to protect the integrated cable 12 passing through an interior thereof. The spring clamp 49 can be configured to clamp the first cable protection sleeve 46 through a fixing spring 47.

The first cable protection sleeve 46 is internally hollow and cylindrical. An inner center of the first cable protection sleeve 46 is provided with a cable threading sleeve 45. A top and a bottom of the cable threading sleeve 45 are each provided with a second ball groove 44 partially enclosing fourth balls 43, thereby reducing the friction of the connecting cable 21 when passing through the cable threading sleeve 45.

The cable hoisting structure includes a hoisting rod 40 and a cylindrical second safety fastener 42 fixedly connected to each other. The hoisting rod 40 is configured to fix the cable hoisting structure to a wall of an inspection well via a second fixing cone 39 passing through a through hole on the hoisting rod. The second safety fastener 42 is internally provided with a first buffer spring 41 for providing a buffering effect when the second safety fastener 42 is separated upon bearing a pulling force reaching a set value.

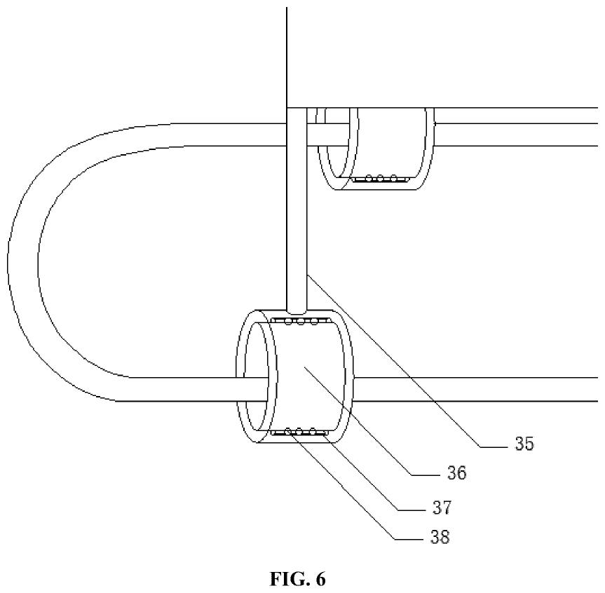

The pipeline trajectory restraint structure includes cable through holes 36 for limiting a movement trajectory of the connecting cable 21 to a top inside the drainage pipeline 85. A top and a bottom of each cable through hole 36 are each provided with a first ball groove 37 partially enclosing third balls 38, thereby reducing the friction of the connecting cable 21 when passing through the cable through holes 36. As shown in FIG. 6, some cable through holes 36 are directly fixed at the top of the drainage pipeline while other cable through holes 36 are fixed at the top of the drainage pipeline 85 via fixing rods 35.

Thus, the first cable protection sleeve 46 is disposed on the wall of the inspection well, and the hoisting rod 40 is fixed to the wall of the inspection well through the second fixing cone 39, so that the first cable protection sleeve 46 and the second cable protection sleeve 48 can be arranged along the wall of the inspection well without affecting personnel entering the well. The second safety fastener 42 can be separated upon bearing the pulling force reaching the set value, and the first buffer spring 41 inside the second safety fastener 42 provides buffer protection. The first cable protection sleeve 46 is internally hollow and cylindrical. An inner middle position of the first cable protection sleeve 46 is provided with the cable threading sleeve 45. When the connecting cable 21 passes through the first cable protection sleeve 46, the collision and frictional resistance can be reduced by the fourth balls 43. The second cable protection sleeve 48 is clamped by the spring clamp 49, so that the integrated cable 12 and the detection system can pass through the second cable protection sleeve 48. When the second cable protection sleeve 48 is subjected to a set downward pulling force, the second cable protection sleeve 48 can disengage from the spring clamp 49, thereby achieving buffer protection for the integrated cable 12. Two ends of the second cable protection sleeve 48 are both fixed to the top of the horizontal drainage pipeline 85 via the fixing rods 35. The connecting cable 21 can pass through the cable through holes 36. Some cable through holes 36 are directly fixed to the top of the drainage pipeline while other cable through holes 36 are fixed to the top of the horizontal drainage pipeline 85 via the fixing rods 35. The third balls 38 can reduce the frictional resistance of the connecting cable 21 when passing through the cable through holes 36.

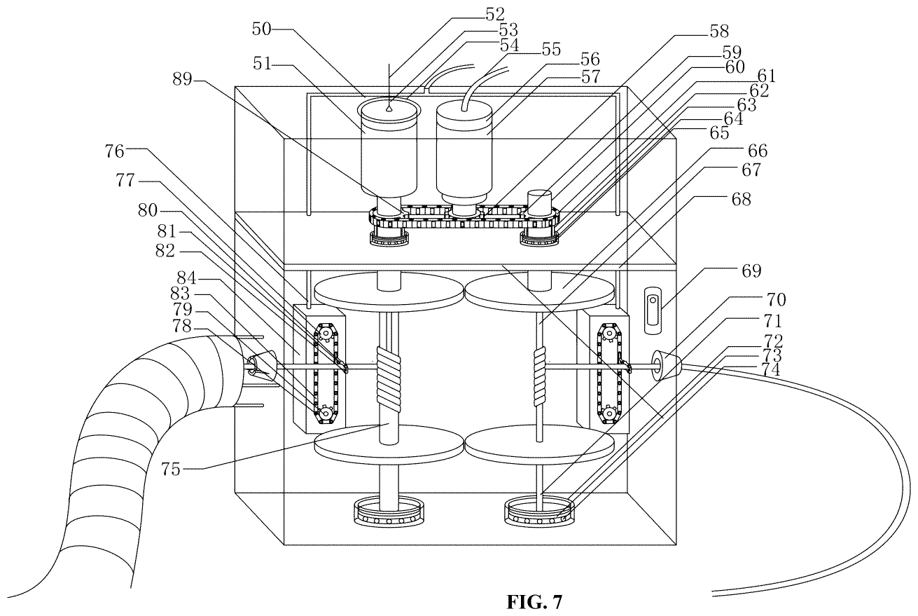

In some embodiments, as shown in FIG. 7, the drive unit includes a first motor 57 and a power controller 56. The power controller 56 is configured to control the first motor 57 to operate.

The transmission unit includes a drive gear 58, a first chain 61, a first driven gear 89, and a second driven gear 59. The drive gear 58 is mounted at a bottom of the first motor 57. The drive gear 58 is configured to drive the first driven gear 89 and the second driven gear 59 to rotate simultaneously via the first chain 61. The first driven gear 89 is fixedly connected to a top of the first cable reel 87 via a first rotating rod at a center thereof. The second driven gear 59 is fixedly connected to a top of the second cable reel 66 via a second rotating rod 60 at a center thereof.

The control device is disposed inside a cabinet 50. An interior of the cabinet 50 is divided into upper and lower parts by a support plate 68. The first driven gear 89 and the second driven gear 59 are separately mounted on the support plate 68 via a gear fixing structure.

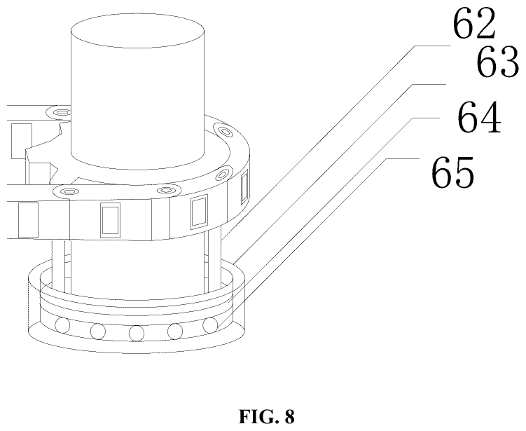

As shown in FIG. 7 and FIG. 8, the gear fixing structure includes gear fixing rods 62, a second clamping slot 63, a first base plate 64, and fifth balls 65. The second clamping slot 63 is provided on the support plate 68. The fifth balls 65 are disposed inside the second clamping slot 63. Tops of the fifth balls 65 are covered by the first base plate 64. An upper surface of the first base plate 64 is fixedly connected to the first driven gear 89 or the second driven gear 59 via a plurality of gear fixing rods 62.

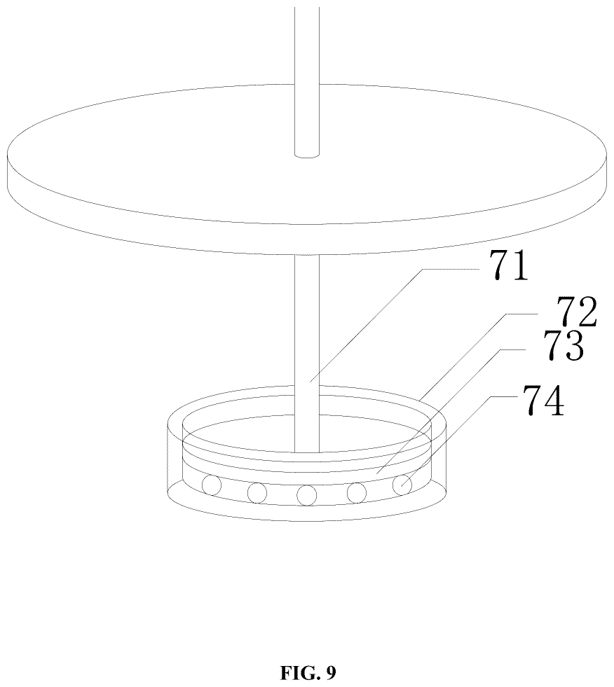

As shown in FIG. 7 and FIG. 9, bottoms of the first cable reel 87 and the second cable reel 66 are each fixedly connected to a first base plate support rod 71. A bottom of the first base plate support rod 71 is fixedly connected to a second base plate 73. A lower part of the second base plate 73 is provided with rollable sixth balls 74. The second base plate 73 and the sixth balls 74 are all disposed inside a third clamping slot 72. The third clamping slot 72 is fixed at a bottom of the cabinet 50.

The cabinet 50 is further provided with two cable winding restraint devices that are respectively configured to achieve regular winding of the integrated cable 12 on the first cable reel 87 and regular winding of the connecting cable 21 on the second cable reel 66.

Each cable winding restraint device includes a first gear 77, a third driven gear 79, a chain rotating shaft 78, a rectangular cable restraint structure, a limit pulley 82, a second chain 83, and a second motor.

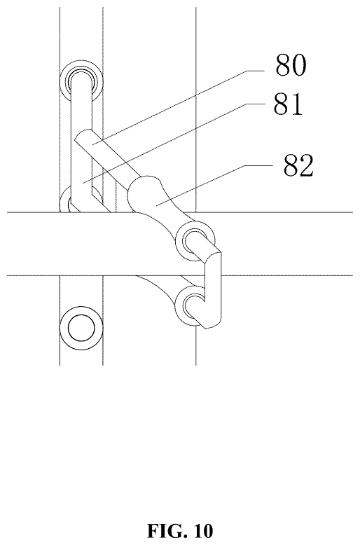

The second motor is located within a motor control box 84. The first gear 77 and the third driven gear 79 are respectively located at upper and lower ends of the motor control box 84. Two ends of the second chain 83 are respectively meshed with the first gear 77 and the third driven gear 79. The second motor is fixedly connected to the first gear 77. The rectangular cable restraint structure is fixed onto two adjacent chain rotating shafts 78 on the second chain 83. As shown in FIG. 10, the rectangular cable restraint structure includes two horizontal rods 80 and two vertical rods 81 connected together. The horizontal rods 80 of the rectangular cable restraint structure are each sleeved with the limit pulley 82. The integrated controller 53 is further connected to the power controller 56 and the second motor.

As an example, a top of the cabinet 50 is provided with a hole 54. Power wires 55 of the drive unit and the second motor are both connected to a power supply of a pump station through the hole 54. The power supply of the pump station is configured to supply power to the drive unit and the second motor. The cabinet 50 is provided with a cabinet door 69.

Thus, the cabinet 50 can be disposed at surface positions such as a position inside a pump station yard. The integrated cable 12 and the connecting cable 21 extend out of the surface from an inspection well 88 adjacent to the pump station to be connected to the cabinet 50. A protection tube for protecting the integrated cable 12 is disposed between a bottom of the inspection well 88 adjacent to the pump station and the cabinet 50. The power controller 56 at the top of the cabinet 50 is configured to control start, stop, a rotation speed, and a rotation direction of the first motor 57. The drive gear 58 is driven by the first motor 57 to drive the first driven gear 89 and the second driven gear 59 at two ends to rotate. The first driven gear 89 and the second driven gear 59 can respectively drive the corresponding first base plate 64 to rotate. The fifth balls 65 can reduce the frictional resistance of the first base plate 64. The first rotating rod can pass without contact through the corresponding second clamping slot 63 and the first base plate 64 to be connected to the first cable reel 87. The second rotating rod 60 can pass without contact through the corresponding second clamping slot 63 and the first base plate 64 to be connected to the second cable reel 66. Since the integrated cable 12 and the connecting cable 21 are respectively wound along different directions on a first middle shaft 75 and a second middle shaft 67, the first cable reel 87 and the second cable reel 66 can rotate such that one of the integrated cable 12 and the connecting cable 21 is released while the other is retracted. When the first cable reel 87 and the second cable reel 66 rotate, the sixth balls 74 can reduce the frictional force of the second base plate 73. The integrated cable 12 is inserted into the middle shaft 75 in the middle of the first cable reel 87 and connected to a storage battery 51 and the integrated controller 53 to enable transmission of signals and power. The integrated controller 53 is respectively connected to a communication antenna 52 and the storage battery 51. A top of the motor control box 84 is connected to a control cable 76. The control cable 76 can be configured to transmit power and control signals. The connecting cable 21 and the integrated cable 12 can both pass through the limit pulley 82 to reduce the frictional resistance. A position of the rectangular cable restraint structure can vary with the rotation of the first gear 77, so that winding positions of the connecting cable 21 and the integrated cable 12 are changed, thereby preventing the cables from piling up locally.

An implementation process of the detection device is as follows:

The cabinet 50 is disposed at a position close to the inspection well 88 inside the pump station yard. The power supply of the pump station is configured to supply energy to the entire detection device. The deployment of the detection device according to this embodiment pertains to two scenarios: a newly built drainage pipeline 85 and an existing drainage pipeline 85. When the detection device is applied to the newly built drainage pipeline 85, during laying of drainage pipeline 85, the structures such as the cable through holes 36, the first cable protection sleeve 46, and the second cable protection sleeve 48 are provided at corresponding positions of a plurality of inspection wells 88 on an inspection route. The cable through holes 36 are fixed inside the drainage pipeline 85 on the inspection route. Subsequently, the connecting cable 21 passes through the provided structures such as the cable through holes 36 and the first cable protection sleeve 46 one by one along the inspection route by starting from the inspection well 88 inside the pump station yard until the connecting cable 21 reaches a starting point of the inspection route. Similarly, the integrated cable 12 passes through a protection tube of the inspection well 88 inside the pump station yard and starts to pass through the second cable protection sleeves 48 in the inspection wells 88 one by one along the inspection route until the integrated cable 12 reaches an inspection well 88 close to the starting point of the inspection route. The inspection carrier 1 is respectively connected to the connecting cable 21 and the integrated cable 12 to complete the deployment. When the detection device is applied to the existing drainage pipeline 85, workers need to work in the well with water. A water-filled condition of the drainage pipeline 85 is a non-full-pipe condition. The cable through holes 36 are fixed at junctions of all inspection wells 88 on an inspection route and the drainage pipeline 85. The first cable protection sleeve 46 and the second cable protection sleeve 48 are fixed on the wall of each inspection well 88. Since there is flowing water in the drainage pipeline 85, a hollow floating ball tied with a string is placed at an upstream starting point of the inspection route. The floating ball first passes through a first cable through hole 36 close to a pipe wall of the drainage pipeline 85 of the starting point. Then, the floating ball floats with the water flow to the adjacent inspection well 88. The workers pick up the floating ball to make the floating ball pass through the cable through hole 36 and the first cable protection sleeve 46 of the inspection well 88. This process is repeated in this way. After the floating ball passes through the cable through holes 36 and the first cable protection sleeves 46 of a plurality of inspection wells 88 and then reaches the cable through hole 36 at a downstream end, the string end at the end of the floating ball is connected to the connecting cable 21. Then, the floating ball is pulled along with the connecting cable 21 to pass through the cable through holes 36 and the first cable protection sleeves 46. Finally, the connecting cable 21 passes through all the cable through holes 36 and the first cable protection sleeves 46, and the connecting cable 21 is inserted into the cabinet. Then, a same method is used. A hollow floating ball tied with a string is placed at an upstream starting point of an inspection route. Then, the floating ball passes through a slightly lower-positioned cable through hole 36. The floating ball tied with a string floats with the water flow to the adjacent inspection well 88. The workers pick up the floating ball to make the floating ball pass through the second cable protection sleeve 48 of the inspection well 88. Then, the second cable protection sleeve 48 is fixed to the wall of the well. This process is repeated in this way until the floating ball reaches the inspection well 88 at the end of the inspection route. Then, the string end at the end of the floating ball is connected to the integrated cable 12. Then, the floating ball is pulled along with the integrated cable 12 to pass through the second cable protection sleeves 48 of the inspection wells 88 on the inspection routes. Finally, the integrated cable 12 is pulled out of the protection tube of the inspection well 88 inside the pump station yard and inserted into the cabinet. At the inspection well 88 at the starting point of the inspection route, the inspection carrier 1 is respectively connected to the connecting cable 21 and the integrated cable 12 to complete the deployment. After the cable system is deployed, the detection device is turned on, the cable system is subjected to a trial run to test the smoothness of the detection system passing through various nodes such as the second cable protection sleeves 48. An appropriate pulling force is applied to pull apart the cable buffers 13 at two ends of the detection system to test whether the first safety fastener 14 can be released smoothly.

Based on any one of the foregoing embodiments, an embodiment of this application further provides a drainage pipeline detection method. The method includes the following steps.

In step S101, the camera devices are turned on, and the first cable reel and the second cable reel are driven by the drive unit to rotate simultaneously, so that the integrated cable is retracted onto the first cable reel while the connecting cable is released from the second cable reel, thereby enabling the detection system to move along a drainage pipeline.

In step S102, video information acquired by the camera devices is obtained from the integrated controller, and the drainage pipeline is detected based on the video information.

In some embodiments, a top of the detection system is provided with an ultrasonic sensor, and a side of the detection system is provided with an ultrasonic liquid level sensor. The detection method according to this embodiment further includes the following contents.

A first distance between the detection system and a top of the drainage pipeline is acquired by the ultrasonic sensor.

A second distance between the detection system and a liquid level inside the drainage pipeline is acquired by the ultrasonic liquid level sensor.

The first distance, the second distance, and a third distance between the ultrasonic sensor and the ultrasonic liquid level sensor are summed to obtain a first height from the top of the drainage pipeline to the liquid level.

A difference between a cross-sectional diameter of the drainage pipeline and the first height is calculated to obtain liquid level information of the drainage pipeline.

The above detection device is used in the drainage pipeline detection method according to this embodiment. The detection system is driven by the integrated cable and the connecting cable to move along the drainage pipeline. Real-time acquisition and transmission of video information inside the drainage pipelines can be achieved in a case that a pipeline network operates normally. In addition, the liquid level information of the drainage pipeline can be obtained by combining the ultrasonic sensor and the ultrasonic liquid level sensor on the detection system.

In the description of the foregoing embodiments, reference to the description of terms such as “some embodiments”, “an example”, and “one example” means that a specific feature, structure, material or characteristic described with reference to the embodiment or example is included in at least one embodiment or example of this application. In this specification, the illustrative expressions of these terms do not necessarily refer to the same embodiment or example. Moreover, the specific feature, structure, material, or characteristic described may be combined in a suitable manner in any one or more embodiments or examples. In addition, without mutual conflict, those skilled in the art may incorporate and combine different embodiments or examples and features of the different embodiments or examples described in this specification.

Other embodiments of this application will be apparent to those skilled in the art from consideration of the specification and implementation of the present disclosure disclosed herein. This application is intended to cover any variations, uses, or adaptive changes of this application. These variations, uses, or adaptive changes follow the general principle of this application and include common general knowledge or conventional technical means in the technical field not disclosed in this application. The specification and embodiments are deemed to be merely illustrative. The true scope and spirit of this application are indicated by the claims.

It should be understood that this application is not limited to the precise structures described above and illustrated in the accompanying drawings, and that various modifications and changes may be made without departing from the scope of this application. The scope of this application is limited only by the appended claims.

What is claimed is:

1. A cable-type device for detecting defects and conditions of drainage pipelines, comprising: a detection system and a cable system, wherein
the detection system comprises an inspection carrier and two camera devices; the two camera devices are mounted on the inspection carrier;
the cable system comprises an integrated cable, a connecting cable, a cable restraint and protection device, and a control device; the control device comprises a drive unit, a transmission unit, a first cable reel, a second cable reel, and an integrated controller; a first end of the integrated cable is connected to an integrated cable socket at a first end of the inspection carrier; a second end of the integrated cable is wound on the first cable reel and electrically connected to the integrated controller; the integrated cable socket is connected to the camera devices; a first end of the connecting cable is connected to a second end of the inspection carrier; a second end of the connecting cable is wound on the second cable reel; the drive unit is configured to drive the first cable reel and the second cable reel to rotate simultaneously via the transmission unit, so that one of the integrated cable and the connecting cable is released while the other is retracted; and the cable restraint and protection device comprises a well protection device and a pipeline trajectory restraint structure that are configured to provide protection for and trajectory restraint to the integrated cable and the connecting cable;
the inspection carrier comprises a carrier connector, two inverted-U-shaped carrier frames, and a shock-absorbing and stabilizing swing curtain, wherein a first end of the carrier connector is internally provided with the integrated cable socket; a second end of the carrier connector is connected to the connecting cable; the two carrier frames semi-enclose the first end and the second end of the carrier connector respectively; a side of the shock-absorbing and stabilizing swing curtain is inverted-T-shaped; a top of the shock-absorbing and stabilizing swing curtain is slidably mounted on a middle part of the carrier connector; the two camera devices are respectively disposed at two ends of an inverted-T-shaped lower part of the shock-absorbing and stabilizing swing curtain; and the integrated cable socket is connected to the two camera devices via a video cable; and
the shock-absorbing and stabilizing swing curtain comprises a swing curtain body, a first rolling shaft, a first shaft sleeve, and plugs, wherein an inner center of the swing curtain body is fixedly connected to the first shaft sleeve that is hollow; the first rolling shaft passes through the first shaft sleeve and has two ends respectively connected to the plugs; left and right sides of an upper surface of the carrier connector are provided with symmetrically distributed movement tracks; the movement tracks are located between the carrier connector and the carrier frames; and the plugs at two ends of the first rolling shaft fit with the movement tracks.

2. The cable-type device according to claim 1, wherein the inspection carrier further comprises two rotation stabilizers; the two rotation stabilizers are correspondingly disposed at the two ends of the inverted-T-shaped lower part of the shock-absorbing and stabilizing swing curtain respectively and configured to stabilize the two camera devices; each of the two rotation stabilizers comprises a stabilizer body wrapped with second balls, a first fixing shaft, and a main spring; a center of the first fixing shaft is connected to a position of a center of gravity of one of the camera devices; two ends of the first fixing shaft are separately connected to a stabilizer body, and the stabilizer body is connected to a hole at a corresponding position on the shock-absorbing and stabilizing swing curtain via the main spring; two ends of the main spring are further connected to low-elasticity springs; and the main spring penetrates into the low-elasticity springs and is wound together with the low-elasticity springs.

3. The cable-type device according to claim 2, wherein the shock-absorbing and stabilizing swing curtain further comprises two first side rails; each first side rail is cylindrical and is internally embedded with a plurality of first balls; each of the first balls is movably disposed inside the first side rail and partially exposed outside the first side rail via through holes on the first side rail; the two first side rails are respectively fixed on inner surfaces of front and rear sides of the swing curtain body;
and the first balls come into contact with an outer surface of the carrier connector.

4. The cable-type device according to claim 2, wherein each of the camera devices comprises a main camera and two top cameras; an upper surface of the main camera is provided with a waterproof eave; two sides of the waterproof eave extend in a streamlined shape and have bent-up bottoms; the two top cameras are respectively disposed below the two sides of the waterproof eave; an upper surface of each top camera is slanted; and a front end of the main camera and a front end of each of the top cameras are respectively provided with a first fill light and a second fill light.

5. The cable-type device according to claim 1, wherein the integrated cable and the connecting cable are each provided with a cable buffer; the cable buffer is cylindrical and is configured to accommodate a wound cable; and the cable buffer comprises two structural parts connected through a first safety fastener; and
the second end of the carrier connector is internally provided with a first fixing cone and a first annular groove; an end portion of the second end of the carrier connector is provided with a first nut; the second end of the carrier connector is in fitting connection with the first fixing cone via a first clamping slot provided at a center of the end portion; and the second end of the carrier connector is in fitting connection with the first annular groove and the first nut respectively via a first fixing ring and a first screw cap disposed on a periphery.

6. The cable-type device according to claim 1, wherein the well protection device comprises a second cable protection sleeve, a spring clamp, a first cable protection sleeve, and a cable hoisting structure; a bottom of the cable hoisting structure is fixedly connected to the first cable protection sleeve; a bottom of the first cable protection sleeve is fixedly connected to an upper part of the spring clamp; the spring clamp is configured to clamp the second cable protection sleeve; and the second cable protection sleeve is configured to protect the integrated cable passing through an interior of the second cable protection sleeve;
the first cable protection sleeve is internally hollow and cylindrical; an inner center of the first cable protection sleeve is provided with a cable threading sleeve; and a top and a bottom of the cable threading sleeve are each provided with a second ball groove partially enclosing fourth balls;
the cable hoisting structure comprises a hoisting rod and a cylindrical second safety fastener fixedly connected to each other, wherein the hoisting rod is configured to fix the cable hoisting structure to a wall of an inspection well via a second fixing cone passing through a through hole on the hoisting rod; and the second safety fastener is internally provided with a first buffer spring for providing a buffering effect when the second safety fastener is separated upon bearing a pulling force reaching a set value; and
the pipeline trajectory restraint structure comprises cable through holes for limiting a movement trajectory of the connecting cable to a top inside the drainage pipeline; and a top and a bottom of each of the cable through holes are each provided with a first ball groove partially enclosing third balls.

7. The cable-type device according to claim 1, wherein the drive unit comprises a first motor and a power controller, and the power controller is configured to control the first motor to operate;
the transmission unit comprises a drive gear, a first chain, a first driven gear, and a second driven gear, wherein the drive gear is mounted at a bottom of the first motor; the drive gear is configured to drive the first driven gear and the second driven gear to rotate simultaneously via the first chain; the first driven gear is fixedly connected to a top of the first cable reel via a first rotating rod at a center of the first driven gear; and the second driven gear is fixedly connected to a top of the second cable reel via a second rotating rod at a center of the second driven gear;
the control device is disposed inside a cabinet; an interior of the cabinet is divided into upper and lower parts by a support plate; and the first driven gear and the second driven gear are separately mounted on the support plate via a gear fixing structure;
the gear fixing structure comprises gear fixing rods, a second clamping slot, a first base plate, and fifth balls, wherein the second clamping slot is provided on the support plate; the fifth balls are disposed inside the second clamping slot; tops of the fifth balls are covered by the first base plate; an upper surface of the first base plate is fixedly connected to the first driven gear or the second driven gear via a plurality of gear fixing rods; and
bottoms of the first cable reel and the second cable reel are each fixedly connected to a first base plate support rod; a bottom of the first base plate support rod is fixedly connected to a second base plate; a lower part of the second base plate is provided with rollable sixth balls; the second base plate and the sixth balls are all disposed inside a third clamping slot; and the third clamping slot is fixed at a bottom of the cabinet.

8. The cable-type device according to claim 7, wherein the cabinet is further provided with two cable winding restraint devices that are respectively configured to achieve regular winding of the integrated cable on the first cable reel and regular winding of the connecting cable on the second cable reel; and
each of the two cable winding restraint devices comprises a first gear, a third driven gear, a chain rotating shaft, a rectangular cable restraint structure, a limit pulley, a second chain, and a second motor;
the second motor is located within a motor control box; the first gear and the third driven gear are respectively located at upper and lower ends of the motor control box; two ends of the second chain are respectively meshed with the first gear and the third driven gear; the second motor is fixedly connected to the first gear; the rectangular cable restraint structure is fixed onto two adjacent chain rotating shafts on the second chain; the rectangular cable restraint structure comprises two horizontal rods and two vertical rods connected together; and the two horizontal rods of the rectangular cable restraint structure are each sleeved with the limit pulley; and
the integrated controller is further connected to the power controller and the second motor.
